(19) United States
(12) Patent Application Publication
(10) Pub. No.: US 2012/0159297 A1
(43) Pub. Date: Jun. 21, 2012

(54) SYSTEM AND METHOD FOR GENERATING A PIVOT TABLE

(75) Inventor: Johan Christiaan Peters, Sankt Leon-Rot (DE)

(73) Assignee: SAP AG, Walldorf (DE)

(21) Appl. No.: 12/975,103

(22) Filed: Dec. 21, 2010

(51) Int. Cl. G06F 17/20; G06F 3/048

(52) U.S. Cl. 715/212

(57) ABSTRACT

Embodiments of the present invention may provide a method for generating a meaningful pivot table. In one embodiment, the method may comprise receiving a command to generate a pivot table for a plurality of related data fields. The data fields may be related to each other in a hierarchy or other relationships. The method may further comprise generating a plurality of pivot table layouts based on a variety of combinations of the related data fields. The combinations may keep an order to maintain the hierarchy of the data fields. The method may further comprising displaying the plurality of pivot table layouts to a user, receiving a user input selecting one particular pivot table layout from the plurality of layouts, and displaying a pivot table according to the selected pivot table layout.

### FIELD

The disclosed subject matter relates to the field of computer systems and, more particularly, to a system and method for generating a set of pivot table layouts to display a set of data fields.

### BACKGROUND

Computer systems often use spreadsheet applications to display sets of data. Pivot tables have been an integral part of the spreadsheet applications to display summarized data. For example, sales data may be summarized based on time (e.g., weeks, months) or location (e.g., cities, states/provinces, regions), and pivot tables have been a useful utility to display the summarized data.

Tools have been developed to help creation or customization of pivot tables. For example, modern spreadsheet applications sometimes provide a software wizard that facilitates generation of a pivot table. The wizard typically allows a user to select the source data from a worksheet list or external database, then provides the user with a worksheet area for the report and a list of the available fields, and then let the user to drag the fields from the list window to the outlined areas. If a pivot table has been generated, the spreadsheet applications can enable customization to re-arrange the table to focus on the information the user wants. For example, the user can change the layout, drag-and-drop data fields, change the format, or drill down to display more detailed data.

However, creating a pivot table for related data fields is a daunting task for an inexperienced user. A lot of times, it is difficult to determine which fields should be combined to generate summarized data and how to select a layout that is easy to interpret the data. While the existing tools are helpful to experienced users, they do not provide enough help to inexperienced users to create meaningful tables with combinations of fields that may be useful and easy to interpret. Accordingly, a need exists for a method and system to help inexperienced users to generate a set of pivot table layouts to display a set of data fields.

### BRIEF DESCRIPTION OF THE DRAWINGS

FIG. 1 illustrates a spreadsheet application according to an embodiment of the present invention.

FIG. 2 illustrates a relationship of selected data fields and a plurality of pivot table layouts generated according to an embodiment of the present invention.

FIG. 3 illustrates a spreadsheet application with data fields selected from available data fields according to an embodiment of the present invention.

FIG. 4 illustrates a spreadsheet application with a drop down list of dynamically generated pivot table layouts according to an embodiment of the present invention.

FIG. 5 illustrates a relationship of selected data fields and a plurality of pivot table layouts generated according to an embodiment of the present invention.

FIG. 6 illustrates another relationship of selected data fields and a pivot table layout generated according to an embodiment of the present invention.

FIG. 7 illustrates a plurality of pivot table layouts generated according to an embodiment of the present invention.

FIG. 8 illustrates a process to generate a meaningful pivot table according to an embodiment of the present invention.

FIG. 9 illustrates a computer system according to an embodiment of the present invention.

### DETAILED DESCRIPTION

Embodiments of the present invention may provide a method for generating a meaningful pivot table. In one embodiment, the method may comprise receiving a command to generate a pivot table for a plurality of related data fields. The data fields may be related to each other in a hierarchy or other relationships. The method may further comprise generating a plurality of pivot table layouts based on a variety of combinations of the related data fields. The combinations may keep an order to maintain the hierarchy of the data fields. The method may further comprise displaying the plurality of pivot table layouts to a user, receiving a user input selecting one particular pivot table layout from the plurality of layouts, and displaying a pivot table according to the selected pivot table layout.

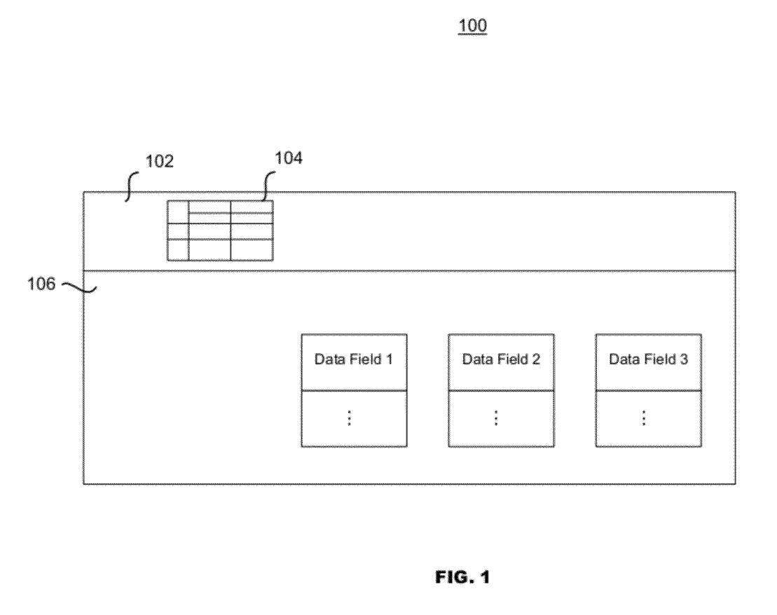

FIG. 1 illustrates a spreadsheet application 100 according to an exemplary embodiment of the present invention. The spreadsheet application 100 may comprise a toolbar 102 and a display area 106. The display area 106 may display a plurality of data fields, such as data field 1, data field 2 and data field 3. The toolbar 102 may comprise a command button 104 for generating a pivot table to display selected data fields. The data fields may be locations (e.g., country, state, city), organization units within a company (e.g., departments, groups), product lines, time (e.g., year, quarter, month), or other categories or information that may be used to group data. In one embodiment, the command button 104 may be a drop down command list that contains a plurality of dynamically generated pivot table layouts based on the selected data fields. That is the pivot table layouts may be generated in response to the selected data fields and according to relationships between the selected data fields. In another embodiment, the command button 104 may initiate a software wizard (e.g., when invoked, it may start a pop up window that guides a user to select data fields, and presents dynamically generated pivot table layouts based on the selected data fields to let the use choose a pivot table for display). In one embodiment, the table layouts may be generated automatically after selecting some database fields. In this embodiment, clicking the command button 104 may display the already generated layouts.

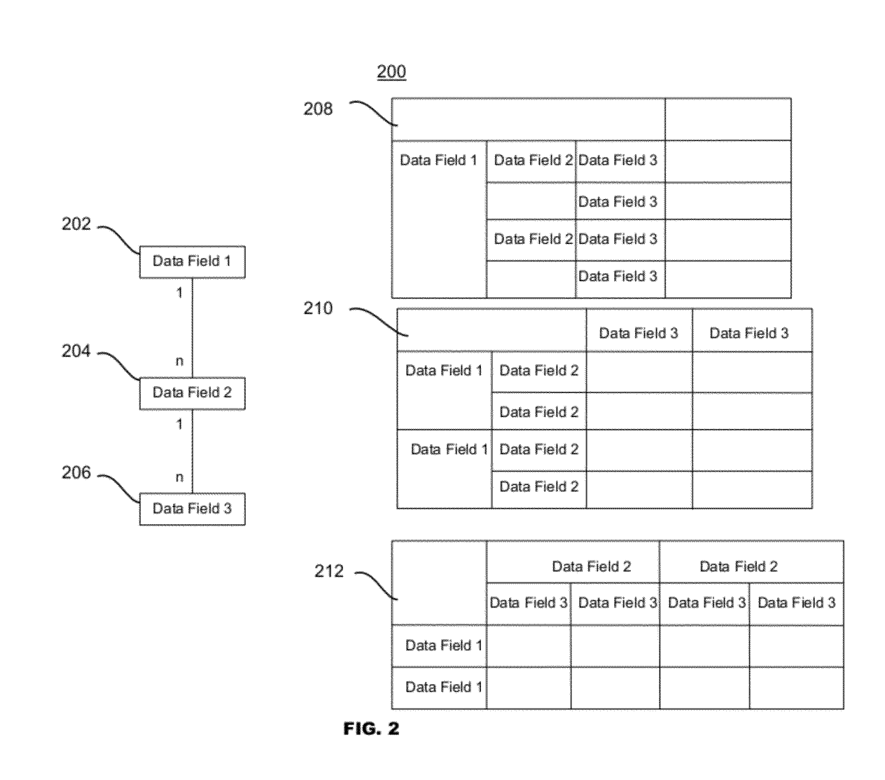

While the pivot tables may be used to display summarized data, the summation of data may be based on a relationship of selected data fields. FIG. 2 illustrates an exemplary relationship of selected data fields and a plurality of pivot table layouts generated according to an embodiment of the present invention. As shown in FIG. 2, the selected data fields 202, 204 and 206 may correspond to data field 1, data field 2, and data field 3 may have a hierarchy such that one data field 1 value may correspond to one or more data field 2 values, and one data field 2 value may correspond to one or more data field 3 values. Based on the relations between the data field 1, data field 2 and data field 3, the possible layouts 208, 210 and 212 may be generated dynamically.

In one embodiment, the possible pivot table layouts may be generated based on the relations between the selected data fields (e.g., a one to many relation between two fields). Further, when the data fields may have a hierarchy, the summation and layouts may be in an order to maintain the hierarchy. For example, the layout 208 may show the data being displayed according to the hierarchy of each data field 1 containing multiple data field 2, and each data field 2 containing multiple data field 3. The layouts 210 and 212 may take advantage of two dimensions of a tabular layout. In the layout 210, data field 1 containing multiple data field 2 may be shown in one dimension and data field 3 may be shown in another dimension. In the layout 212, data field 1 may be shown in one dimension and data field 2 containing multiple data field 3 may be shown in another dimension. Thus, as long as the order is maintained, any combination of data fields may be used as part of a pivot table. It should be noted that the position of the data fields may be inverted. That is, data fields may be either on top or left of a tabular presentation. Accordingly, the number of possible layouts may be doubled.

The data fields may be grouped in field sets. The number of sets may be calculated by the equation of

$${\sum }_{i = 1}^{N} \frac{N !}{( N - i ) ! \times {i !}^{′}} ,$$

where N may stand for the number of data fields available. For the example of the data field 1, 2 and 3, the available field sets may seven field sets include, data field 1, data field 2, data field 3, data field 1 and data field 2, data field 1 and data field 3, data field 2 and data field 3, data field 1 and data field 2 and data field 3. If a data field is not shown in a tabular layout, it may be used as filter fields to filter the data to be displayed.

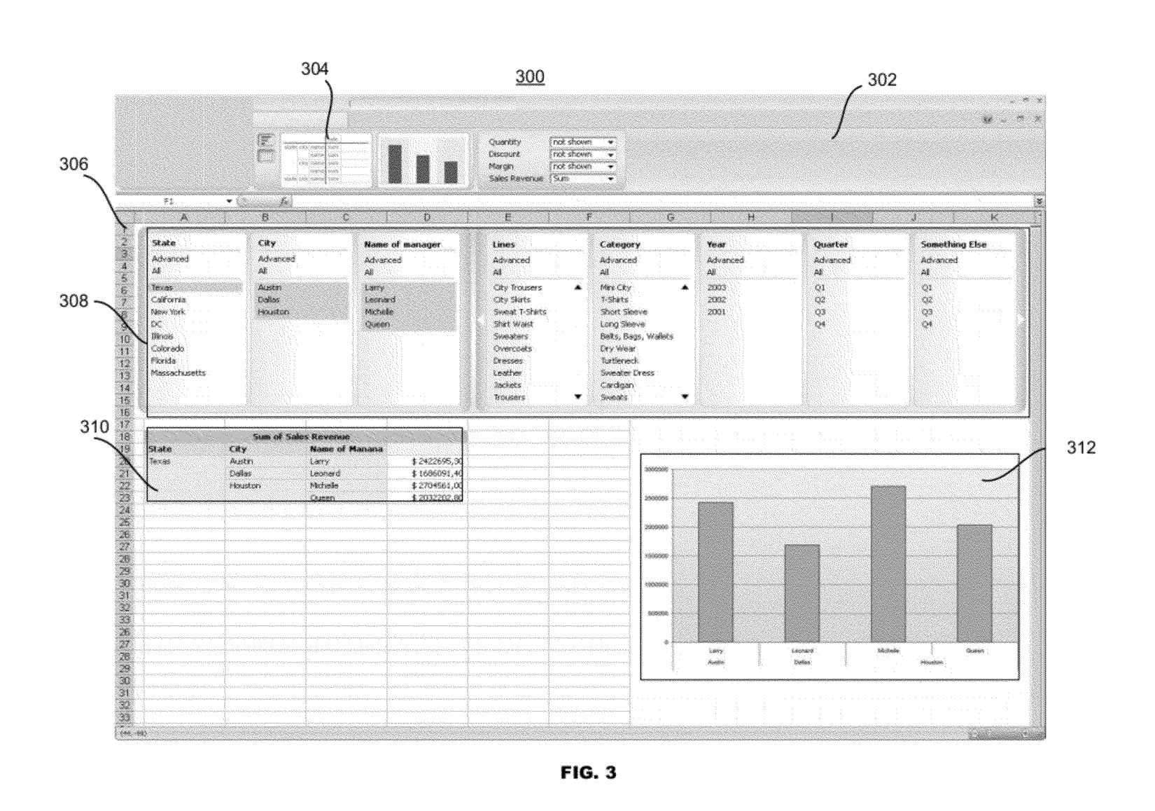

FIG. 3 illustrates a spreadsheet application 300 with data fields selected from available data fields according to an embodiment of the present invention. The spreadsheet application 300 may comprise a toolbar 302 and a display area 306. The display area 306 may display, in a block 308, a plurality of tables for available data fields. The data fields may include locations (e.g., state, city), names of manager, lines of product, category of product, time period of interest. The display area 306 may further include a table 310 and a bar chart 312. The table 312 may show the selected data fields of interest and the bar chart 312 may show the data of selected data fields of interest in a bar chart. The toolbar 302 may comprise a command button 304 for generating a pivot table to display the selected data fields.

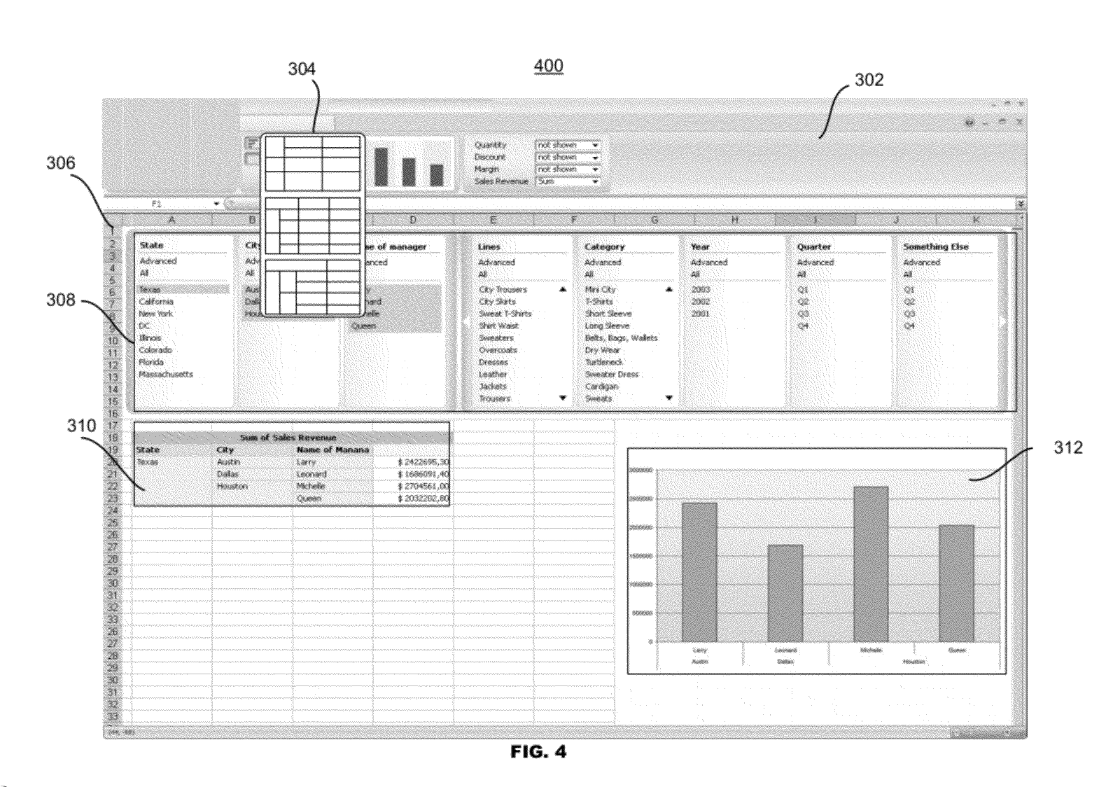

In one embodiment, the command button 304 may be a drop down command list that contains a plurality of dynamically generated pivot table layouts based on the selected data fields as shown in FIG. 4, which illustrates the spreadsheet application 300 with a drop down list of dynamically generated pivot table layouts according to an embodiment of the present invention.

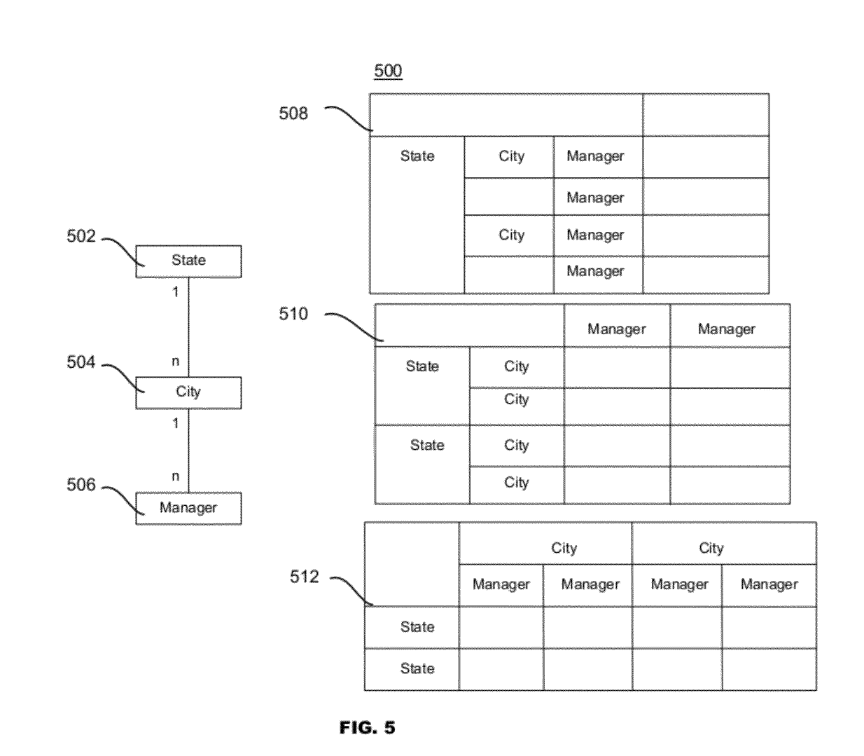

FIG. 5 illustrates a relationship of selected data fields and a plurality of pivot table layouts generated according to an embodiment of the present invention. As shown in FIG. 5, the selected data fields may be state 502, city 504 and manager 506, and these three data fields may have a hierarchy such that one state may have one or more cities, and one city may have one or more managers. Based on the relations between the data fields of the state 502, city 504 and manager 506, the possible layouts 508, 510 and 512 may be generated according to cardinalities of the relations between the selected data fields. The layouts may display data in an order to maintain the hierarchy. For example, the layout 508 display data according to the hierarchy of each state containing multiple cities, and each city containing multiple managers. The layouts 510 and 512 may take advantage of two dimensions of a tabular layout. In the layout 510, each state containing multiple cities may be shown in one dimension and corresponding managers may be shown in another dimension. In the layout 512, each state may be shown in one dimension and corresponding cities each containing multiple managers may be shown in another dimension. Thus, as long as the order is maintained, any combination of data fields may be used as part of a pivot table.

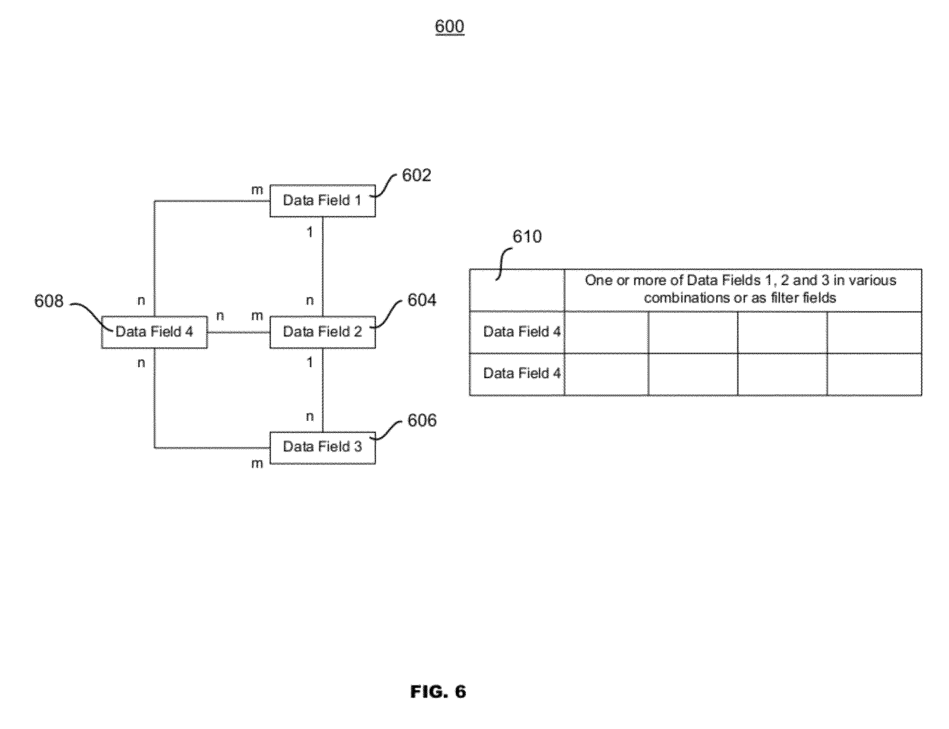

FIG. 6 illustrates another relationship of selected data fields and a pivot table layout generated according to an embodiment of the present invention. The data fields 602, 604 and 606 may correspond to data fields 1, 2 and 3 as shown in FIG. 2, and thus, have similar relations among them. In addition, FIG. 6 may comprise an additional data field 608 that corresponds to a data field 4. The data field 4 may have an n:m relationship with each of three data fields: the data fields 1, 2 and 3. Thus, there is no hierarchy between the data field 4 and either of data fields 1, 2 or 3. In one embodiment, the data field 4 may be displayed by itself in tabular or matrix layout. For example, the pivot table layout 610 may show that the data field 4 may be used at one axis for a table. In another embodiment, the data field 4 may be used as a filter field to selectively display data pertaining only to the data field 4.

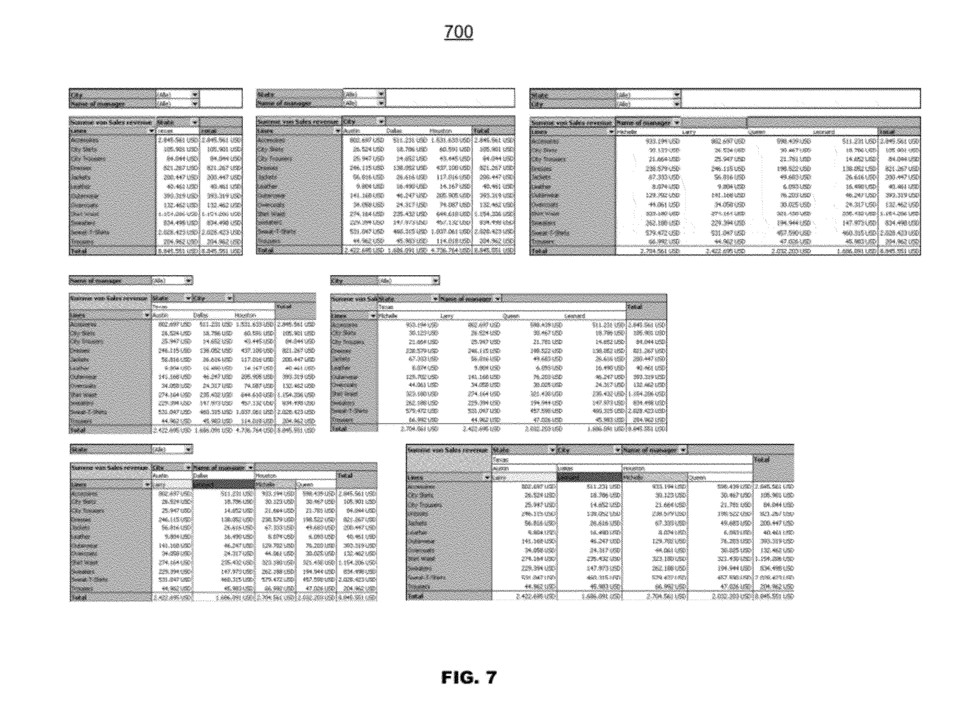

FIG. 7 illustrates a plurality of pivot table layouts generated according to an embodiment of the present invention. Lines may be another data field to be selected from the available data fields in FIG. 3, in addition to state, city and manager data fields. Because lines have an n:m relationship with each of the state, city and manager data fields, lines may be displayed on an opposite axis with respect to the state, city and manager data fields. In one embodiment, the lines filed may be put on the top of the tabular display and thus, the number of possible layouts may be doubled.

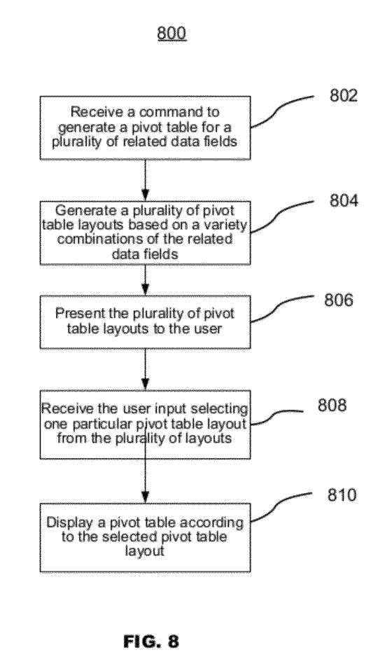

FIG. 8 illustrates a process 800 to generate a meaningful pivot table according to an embodiment of the present invention. At block 802, a command to generate a pivot table for a plurality of related data fields may be received from a user. In one embodiment, the user may select a plurality of data fields from available data fields and try to generate a meaningful pivot table. The meaningful pivot table may summarize the data in a useful way and have a layout that is easy to interpret the data. At block 804, a plurality of pivot table layouts based on a variety of combinations of the related data fields may be generated dynamically. The generated pivot table layouts may maintain an order according to the relations between the selected data fields. At block 806, the plurality of pivot table layouts may be presented to the user. In one embodiment, the layouts may be shown in a drop down list. In another embodiment, the layouts may be shown in a popup window. At block 808, a user input may be received to select one particular pivot table layout from the plurality of layouts. At block 810, a pivot table according to the selected pivot table layout may be displayed.

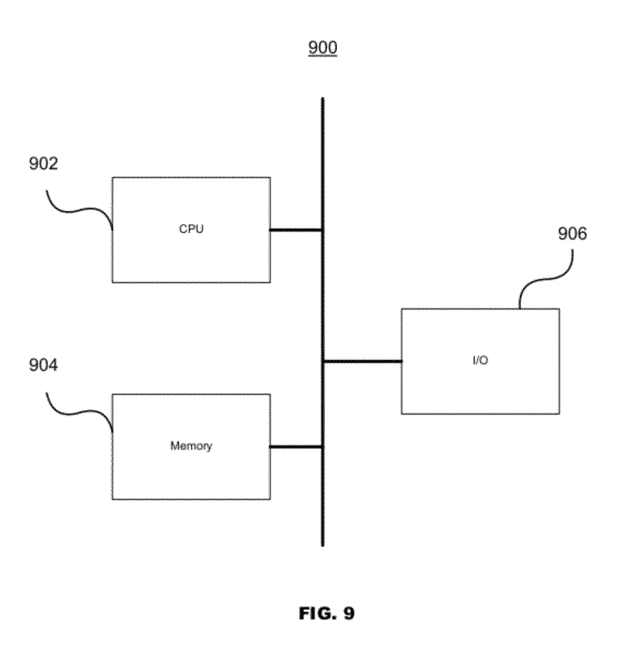

FIG. 9 illustrates a computer system 900 according to an embodiment of the present The computer system 900 includes a processor 902, memory 904, and an I/O device(s) 906. The processor 902 is connected to the memory 904 and I/O device(s) 906. These connections are direct or via other internal electronic circuitry or components.

The processor 902 is a programmable processor that executes instructions residing in the memory 904 to receive and send data via the I/O device(s) 906. The instructions may perform the operations of a message handling system according to an exemplary embodiment. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 902 is an Intel® microprocessor.

Memory 904 is a machine-readable medium that stores data that is processed by processor 902. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 902 via one or more I/O device(s) 906.

The I/O device(s) 906 may be one or more input/output interfaces that receive and/or send digital data to and from an external device. Interfaces as used herein are any point of access to an external device where digital data is received or sent, including ports, buffers, queues, subsets thereof, or any other interface to an external device.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer implemented method, the method comprising:
receiving, by a computer processor, a command to generate a pivot table for a plurality of related data fields;
generating, by the computer processor, a plurality of pivot table layouts based on a variety of combinations of the related data fields;
displaying, by the computer processor, the plurality of pivot table layouts to a user;
receiving, by the computer processor, the user input selecting one particular pivot table layout from the plurality of layouts; and
displaying, by the computer processor, a pivot table generated according to the selected pivot table layout.

2. The computer implemented method of claim 1, wherein each of the combinations of the related data fields maintains a hierarchy of the related data fields.

3. The computer implemented method of claim 2, wherein each of the combinations of the related data fields is grouped based on cardinalities between of the related data fields.

4. The computer implemented method of claim 1, wherein the plurality of pivot table layouts are displayed in a drop down list for a command button.

5. The computer implemented method of claim 1, wherein the plurality of pivot table layouts are displayed in a pop up window.

6. The computer implemented method of claim 1, wherein one or more data fields not included in a combination is used as a filter data field to filter the data to be displayed.

7. The computer implemented method of claim 1, wherein each layout displays a data field or a combination of the related data fields on top or left of a matrix.

8. A system for displaying messages in a structured way, comprising:
a memory to store computer program instructions; and
a processor configured to execute the computer program instructions to:
receive a command to generate a pivot table for a plurality of related data fields;
generate a plurality of pivot table layouts based on a variety of combinations of the related data fields;
display the plurality of pivot table layouts to a user;
receive the user input selecting one particular pivot table layout from the plurality of layouts; and
display a pivot table generated according to the selected pivot table layout.

9. The system of claim 8, wherein each of the combinations of the related data fields maintains a hierarchy of the related data fields.

10. The system of claim 9, wherein each of the combinations of the related data fields is grouped based on cardinalities between of the related data fields.

11. The system of claim 8, wherein the plurality of pivot table layouts are displayed in a drop down list for a command button.

12. The system of claim 8, wherein the plurality of pivot table layouts are displayed in a pop up window.

13. The system of claim 8, wherein one or more data fields not included in a combination is used as a filter data field to filter the data to be displayed.

14. The system of claim 8, wherein each layout displays a data field or a combination of the related data fields on top or left of a matrix.

15. A non-transitory computer-readable storage medium embodied with program instructions for causing a computer to display a meaningful pivot table, the method comprising:
receiving a command to generate a pivot table for a plurality of related data fields;
generating a plurality of pivot table layouts based on a variety of combinations of the related data fields;
displaying the plurality of pivot table layouts to a user;
receiving the user input selecting one particular pivot table layout from the plurality of layouts; and
displaying a pivot table generated according to the selected pivot table layout.

16. The non-transitory computer-readable storage medium of claim 15, wherein each of the combinations of the related data fields maintains a hierarchy of the related data fields.

17. The non-transitory computer-readable storage medium of claim 16, wherein each of the combinations of the related data fields is grouped based on cardinalities between of the related data fields.

18. The non-transitory computer-readable storage medium of claim 15, wherein the plurality of pivot table layouts are displayed in a drop down list for a command button.

19. The non-transitory computer-readable storage medium of claim 15, wherein the plurality of pivot table layouts are displayed in a pop up window.

20. The non-transitory computer-readable storage medium of claim 15, wherein one or more data fields not included in a combination is used as a filter data field to filter the data to be displayed.
